(19) United States
(12) Patent Application Publication
(10) Pub. No.: US 2017/0006176 A1
(43) Pub. Date: Jan. 5, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Takeshi TAKEI, Kanagawa (JP); Tsubasa NISHINO, Kanagawa (JP)

(73) Assignee: FUJI XEROX CO., LTD., Tokyo (JP)

(21) Appl. No.: 15/002,635

(22) Filed: Jan. 21, 2016

(30) Foreign Application Priority Data
Jul. 3, 2015 (JP) 2015-134621

(51) Int. Cl. H04N 1/00; G06F 17/30

(52) U.S. Cl. CPC H04N 1/00811; H04N 1/00822; H04N 1/00474; H04N 1/00806; G06F 17/30864

(57) ABSTRACT

An information processing apparatus includes an instruction unit that instructs an image reading unit to read an image in accordance with a predetermined configuration related to image reading if a predetermined service is selected from among plural services, and an execution unit that performs an operation responsive to the selected service using operation results of the image reading unit.

### CROSS-REFERENCE TO RELATED APPLICATIONS

This application is based on and claims priority under 35 USC 119 from Japanese Patent Application No. 2015-134621 filed Jul. 3, 2015.

### BACKGROUND

(i) Technical Field

The present invention relates to an information processing apparatus, an information processing method, and a non-transitory computer readable medium.

(ii) Related Art

Mechanisms that manage books and magazines with a computer are currently available.

### SUMMARY

According to an aspect of the invention, there is provided an information processing apparatus. The information processing apparatus includes an instruction unit that instructs an image reading unit to read an image in accordance with a predetermined configuration related to image reading if a predetermined service is selected from among plural services, and an execution unit that performs an operation responsive to the selected service using operation results of the image reading unit.

### BRIEF DESCRIPTION OF THE DRAWINGS

Exemplary embodiments of the present invention will be described in detail based on the following figures, wherein:

FIG. 1 is a block diagram illustrating a configuration of an information processing system of an exemplary embodiment of the present invention;

FIG. 2 is a block diagram illustrating a configuration of an image processing apparatus of the exemplary embodiment;

FIG. 3 is a block diagram illustrating a configuration of a server apparatus of the exemplary embodiment;

FIG. 4A through FIG. 4C illustrate examples of data stored on the server apparatus;

FIG. 5A through FIG. 5C illustrate external views of a book;

FIG. 6A and FIG. 6B illustrate external views of a magazine and a user card;

FIG. 7 illustrates a functional configuration of an information processing system;

FIG. 8A and FIG. 8B illustrate examples of screens displayed on the image processing apparatus;

FIG. 9A through FIG. 9D illustrate examples of screens displayed on the image processing apparatus;

FIG. 10 is a flowchart illustrating a standard process of the server apparatus in a book management service;

FIG. 11A through FIG. 11D illustrate examples of screens displayed on the image processing apparatus;

FIG. 12A through FIG. 12D illustrate examples of screens displayed on the image processing apparatus; and

FIG. 13A and FIG. 13B illustrate examples of original documents.

### DETAILED DESCRIPTION

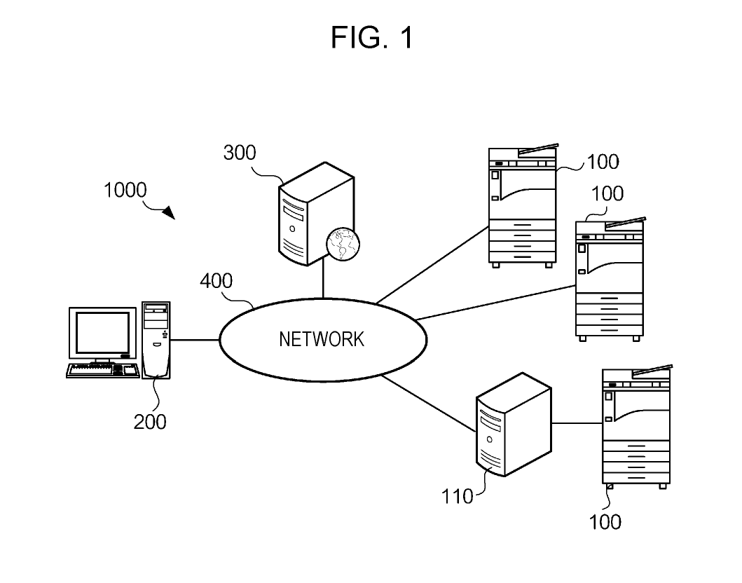

FIG. 1 is a block diagram illustrating a configuration of an information processing system 1000 of an exemplary embodiment of the present invention. The information processing system 1000 provides users with a variety of services including a book management service, an in-house mail delivery service, and a marker masking service. The book management service is intended to manage books. The in-house mail delivery service is intended to deliver an in-house mail. The in-house mail delivery service includes a delivery monitoring service configured to monitor the delivery status of data, such as an image, when the data is being delivered. The marker masking service is intended to mask a predetermined color region.

The information processing system 1000 includes an image processing apparatus 100 installed in a building of a library or an office building, a server apparatus 200 that is run by an operator of a library or an in-house operator of a company, a bibliographic information storage device 300 operated by an administrator of a national library or a bibliographic information providing site, and a network 400 that interconnects these apparatuses 100 through 300. The image processing apparatus 100 implements an image reading function and an image forming function. The server apparatus 200 analyzes the image read by the image processing apparatus 100. When the book management service is used, the server apparatus 200 acquires bibliographic information from the bibliographic information storage device 300, and performs an operation to manage books. The operations related to managing books include at least one of an operation to register or delete a book on a database on the server apparatus 200, an operation of updating the database to lend a book, and an operation of updating the database to receive a book returned. When the in-house mail delivery service is used, the server apparatus 200 delivers the read image using in-house mail. When the in-house mail delivery service is used, the server apparatus 200 monitors the delivery status of the read image that is being delivered. When the marker masking service is used, the server apparatus 200 analyzes the read image, and masks an area filled by a marker.

The bibliographic information storage device 300 is used to provide the book management service. The bibliographic information storage device 300 is a web server apparatus that stores the bibliographic information of a large number of books, and provides the bibliographic information via the network 400. The network 400 includes a variety of networks including a local area network (LAN), a virtual private network (VPN), and the Internet.

The number of image processing apparatuses 100, the number of server apparatuses 200 and the number of bibliographic information storage devices 300 are not limited to those illustrated in FIG. 1. The functions of the server apparatus 200 may be implemented by one of the image processing apparatuses 100, or may be implemented by an information processing apparatus 110 as a front-end device connected to an image processing apparatus 100. The functions of the server apparatus 200 may be distributed among multiple server apparatuses, and the server apparatuses cooperate to perform the functions equivalent to those of the server apparatus 200. For example, a server apparatus may be provided on a per provided service basis. The functions of the server apparatus 200 may be provided in cloud service. The configuration (the image processing apparatus 100, the server apparatus 200, and the information processing apparatus 110) other than the bibliographic information storage device 300 may be implemented in a single apparatus.

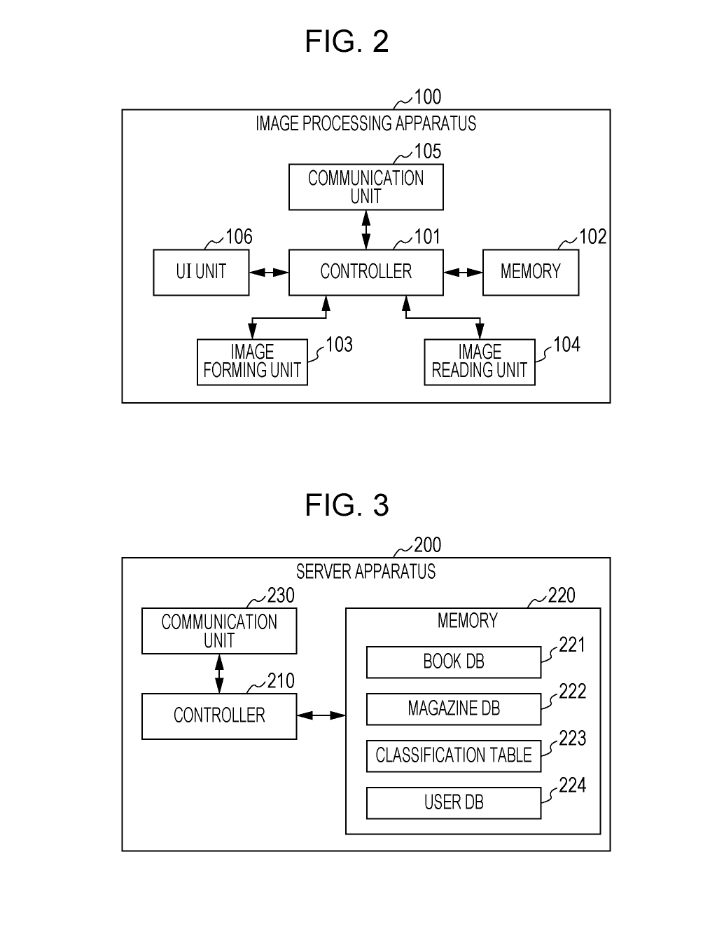

FIG. 2 is a block diagram illustrating a configuration of the image processing apparatus 100 of the exemplary embodiment. The image processing apparatus 100 includes a controller 101, a memory 102, an image forming unit 103, an image reading unit 104, a communication unit 105, and a user interface (UI) unit 106. The controller 101 controls the elements of the image processing apparatus 100, and includes a control circuit, such as an application specific integrated circuit (ASIC) or a central processing unit (CPU), and a variety of memories. The memory 102 may be a hard disk, for example, and store a program to be executed by the CPU or data used in the execution of the program. The image forming unit 103 forms an image on a medium through an electrophotographic system. The image forming unit 103 forms a latent image on a photoconductor drum as an image holder by emitting a laser beam onto the photoconductor drum, develops the latent image with yellow (Y) toner, magenta (M) toner, cyan (C) toner, and black (K) toner, transfers the toner image onto a medium such as a recording sheet, and outputs the medium through a fixing operation.

The image reading unit 104 generates image data by optically reading an image on an original document. The image reading unit 104 includes a platen glass on which an original document is to be placed. The image reading unit 104 recognizes the size of the original document placed on the platen glass, and generates the image data of the recognized size. The communication unit 105 transmits and receives data and communicates with the server apparatus 200 via the network 400. The UI unit 106 interactively communicates with the user. The UI unit 106 includes an operation module including an operator, such as a touch sensor and a control, and supplying an operation signal responsive to an operation of the user to the controller 101, and a display including a liquid-crystal panel and a liquid-crystal driving circuit and displaying an image under the control of the controller 101.

The memory 102 stores a configuration value on each function related to image reading. More specifically, the memory 102 stores a configuration value indicating whether to perform a background removal operation in the image reading or not, a configuration value as to whether the distortion correction is to be performed or not, a configuration value as to whether image reading is performed in color or monochrome, and a configuration value as to whether the read image data is output in color or monochrome. The background removal operation is to remove the background of the original document image. The distortion correction is to correct a distortion in the original document image caused in the reading operation. The configuration value of the background removal operation is “ON” or “OFF”. If the background removal operation is configured to be “ON”, the controller 101 performs the background removal operation on the read image data. If the configuration value is “OFF”, the controller 101 does not perform the background removal operation.

The user of the image processing apparatus 100 may configure the image processing apparatus 100 for these configuration values using the UI unit 106. The controller 101 in the image processing apparatus 100 performs an imaging processing operation in response to the configuration value on each function stored on the memory 102 (or instructs the image reading unit 104 to perform the image processing operation). For example, if the configuration value of the background removal operation is “ON”, the controller 101 performs the background removal operation on the image data read by the image reading unit 104. If the configuration value of the image reading is configured to be performed in “color”, the controller 101 instructs the image reading unit 104 to read the image in color.

FIG. 3 is a block diagram illustrating a hardware configuration of the server apparatus 200 of the exemplary embodiment. The server apparatus 200 includes a controller 210, a memory 220, and a communication unit 230. The controller 210 controls each element of the server apparatus 200. The controller 210 includes a control circuit, such as a CPU, and a variety of memories. By executing a program, the controller 210 controls the operation of each element in the server apparatus 200. The memory 220 stores data that is used by the server apparatus 200. The memory 220 is a hard disk, for example, and stores the program to be executed by the controller 210, and data used in the execution of the program. The memory 220 stores a library database (DB) 221, a magazine DB 222, a classification table 223, and a user DB 224. The communication unit 230 transmits and receives data, and communicates with the image processing apparatus 100 or the bibliographic information storage device 300 via the network 400.

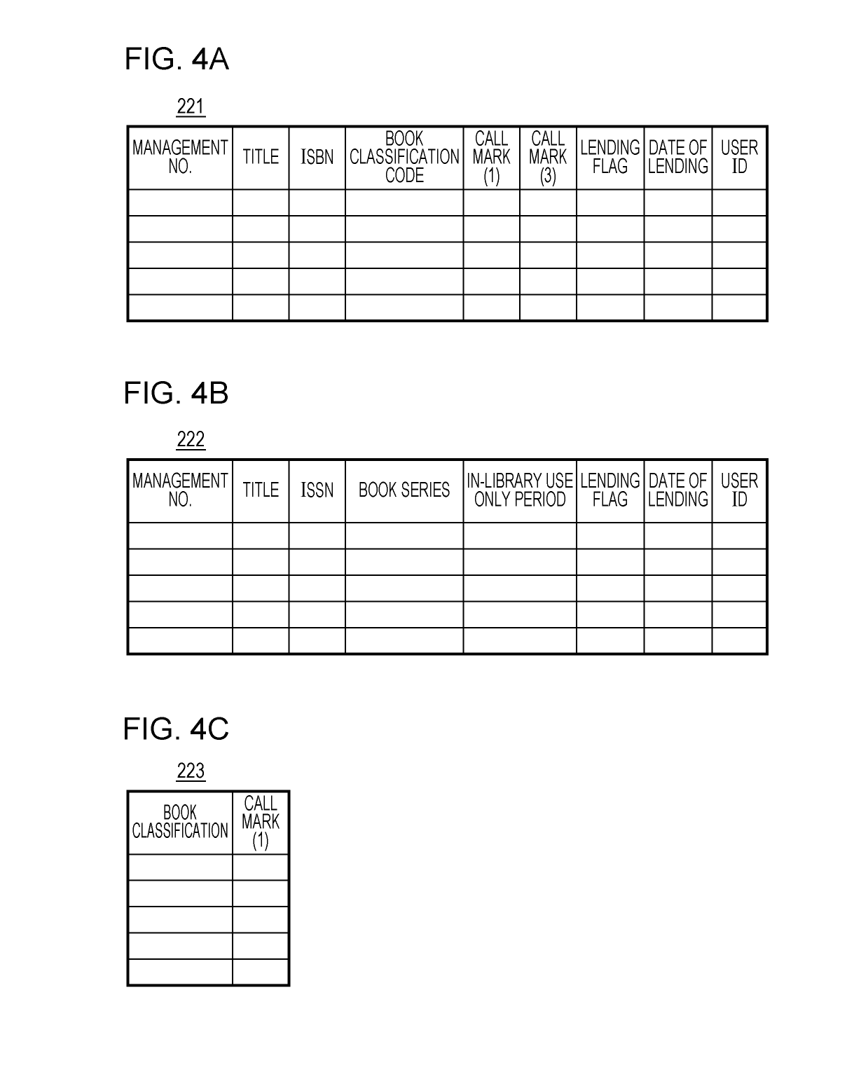

FIG. 4A through FIG. 4C illustrate part of contents of the book DB 221, the magazine DB 222, and the classification table 223. The book DB 221, the magazine DB 222, and the classification table 223 are referenced in the book management service. The books managed in the book management service are largely divided into books and magazines. Each of the books typically written by one or more writers and edited by an editor is published as one complete book, but the books also include a series of books or an encyclopedia. In contrast, a magazine is published periodically with the same title, and is tagged with a volume (series), a volume number, part, or serial number. The books and magazines are identified by international standard numbers. For example, each book is identified by a 10-digit or 13-digit international standard book number (ISBN), and a magazine is identified by an 8-digit or 13-digit international standard serial number (ISSN).

In the book DB 221, the management numbers are identification information that identifies the books stored in a library one by one. The title is a book title. Even if multiple books have the same title, they are tagged with different management numbers. ISBN is an international standard book number attached to the corresponding book. Book classification code indicates a standard classification determined in accordance with the subject and contents of each book. In Japan, Nippon Decimal Classification 9th edition (NDC9) is used. Call mark (1) is classification of the books used in each library, for example. NDC9 or a classification independently defined by each library is used as call mark (1). Typically, the shelving locations of books and the arrangement order of bookshelves are determined in accordance with the classification uniquely defined by each library, and thus the call mark (1) defines the shelving locations of books and the arrangement order of bookshelves in each library. Call mark (3) is a classification of a series of books or an encyclopedia that is published in series. The call mark (3) classifies the series of books or the encyclopedia according to the number of volumes or date of publication. The call mark (3) is a serial number included in the call mark (1). In the call mark (3), books having the same title are typically identified by the same number. A lending flag indicates whether a book is currently being lent. A date of lending indicates the date on which the book is lent. A user identity (ID) is identification information of a user who has borrowed the book if the book is being lent.

Data in the magazine DB 222 may be identical to data in the book DB 221 if the term “book” in the book DB 221 is replaced with the term “magazine”. Note that the magazine DB 222 includes a column “in-library use only period” throughout which the lending of a magazine of interest is not allowed from the date of publication.

The classification table 223 indicates the correspondence between a book classification code serving as a standard classification of books and the call mark (1) serving as a classification of books unique to each library. The classification table 223 enables the standard book classification code, such as NDC9, to be converted into the call mark (1) typically used in libraries. The user DB 224 includes a user ID assigned to each user and attributes of the user.

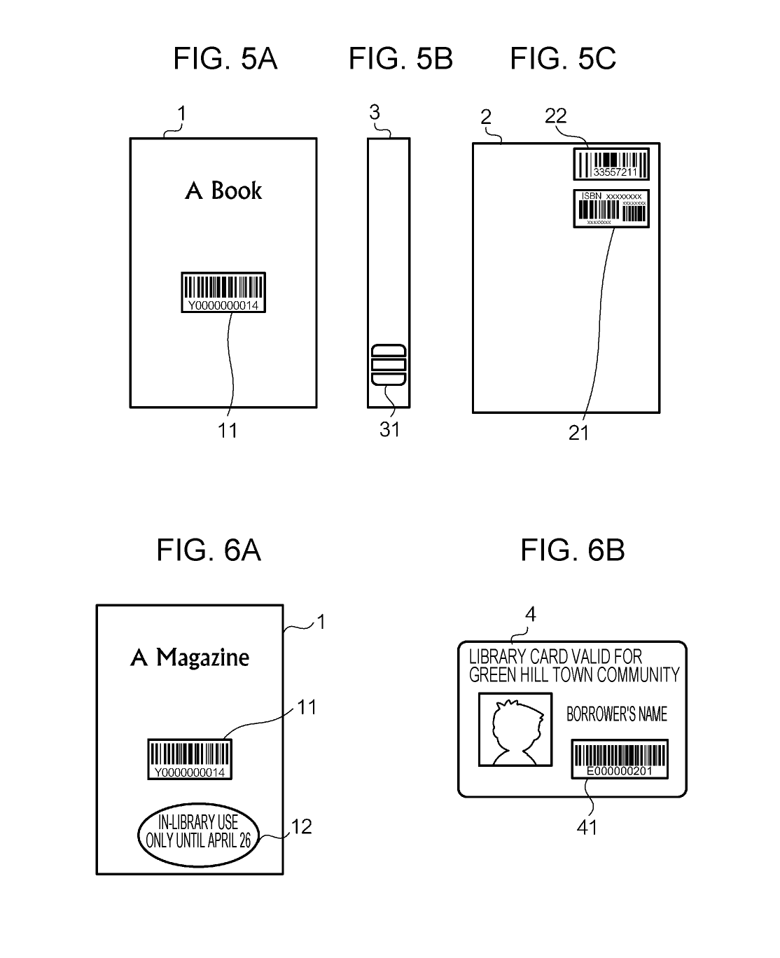

FIG. 5A through FIG. 5C are plan views illustrating an example of an external appearance of a book. Referring to FIG. 5A through FIG. 5C, a management barcode 11 indicating a management number is glued onto a cover 1 of the book. As previously described, the management barcode 11 identifies each of the books one by one. For example, the management number is “YB000123” in the case of a book, and “YM0000123” in the case of a magazine. Using an identifier “YB” representing a book and an identifier “YM” representing a magazine as part of the management number, books and magazines are thus identified using the management number. The management barcode 11 is glued onto the cover 1 in this case. Alternatively, the management barcode 11 may be glued onto a back cover 2 or a spine 3 of the book.

Glued onto or printed on the back cover 2 of the book are an ISBN barcode 21 indicating the ISBN or an ISSN barcode 21 indicating the ISSN granted to the book, and a price barcode 22 indicating the price of the book. A label 31 is glued onto the spine 3. The label 31 includes three row sections. The call mark (1) is written on the top row section, and the call mark (3) is written on the bottom row section.

In the case of magazines, an in-library use only label 12 indicating the in-library use only period is glued onto the cover 1 of a magazine (see FIG. 6). Book lending is performed on a user who has the user card 4 illustrated in FIG. 6A. A user ID barcode 41 indicating a user ID identifying each user is printed on or glued on the user card 4. The form representing each piece of above described information does not necessarily have to be a barcode. As long as the information is in an encoded form, the information is acceptable.

FIG. 6A and FIG. 6B are plan views illustrating the external appearance of the magazine and the user card. In the case of the magazines, an in-library use only label 12 indicating the in-library use only period is glued on the cover 1 of the magazine. Lending is performed on a user who holds the user card 4 of FIG. 6B. The user ID barcode 41 indicating a user ID identifying each user is printed on or glued on the user card 4. The form representing each piece of above described information does not necessarily have to be a barcode. As long as the information is in an encoded form, the information is acceptable.

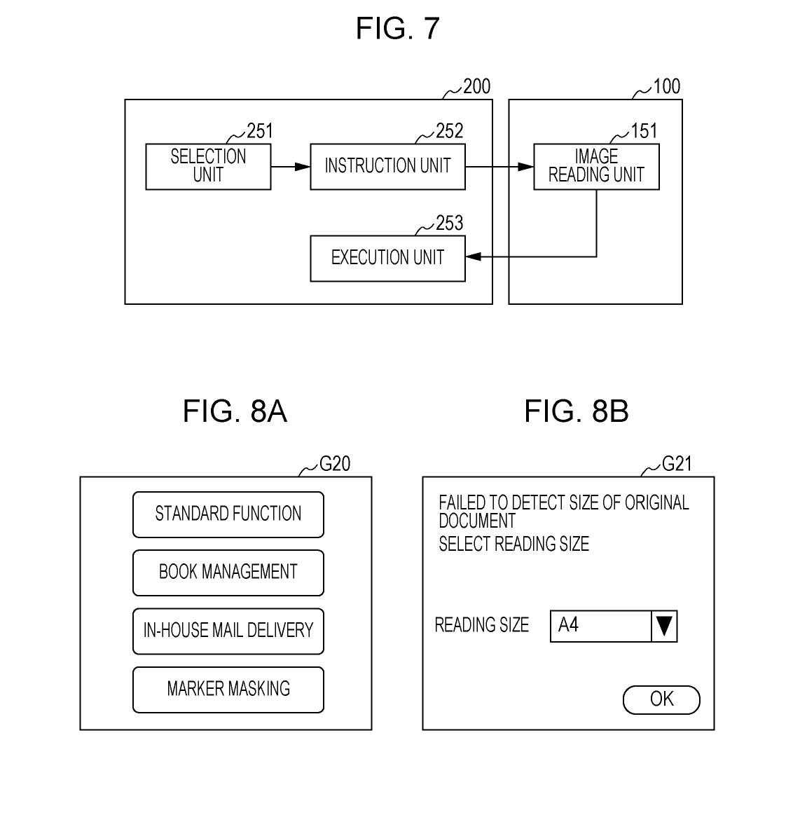

FIG. 7 illustrates the functional configuration of the information processing system 1000. The image processing apparatus 100 includes an image reading unit 151. The image reading unit 151 performs an image reading operation in accordance with operation contents specified by a configuration value of each function related to the image reading. The server apparatus 200 includes a selection unit 251, an instruction unit 252, and an execution unit 253. The selection unit 251 selects one of the multiple services provided by the information processing system 1000. If a predetermined service is selected by the selection unit 251, the instruction unit 252 instructs the image reading unit 151 to read an image in accordance with the configuration related to the image reading. The execution unit 253 executes an operation responsive to the service selected by the selection unit 251, using the operation results of the image reading unit 151. The selection unit 251, the instruction unit 252, and the execution unit 253 are implemented by a software process of the controller 210. The controller 101 and the image reading unit 104 are examples of the image reading unit 151.

FIG. 8A and FIG. 8B illustrate examples of screens displayed on the user interface (UI) unit 106 of the image processing apparatus 100. The user selects a desired service on a service selection screen G20 of FIG. 8A. When the user selects a service, the controller 101 in the image processing apparatus 100 selects the service in response to information output from the UI unit 106. From among soft buttons indicating “standard function”, “book management”, “in-house mail delivery”, and “marker masking”, the soft buttons “book management” and “in-house mail delivery” are associated with uniform resource locators (URLs). If the user selects one of the services “book management”, “in-house mail delivery”, and “marker service”, the controller 101 in the image processing apparatus 100 transmits a hypertext transfer protocol (HTTP) request to the URL associated with the selected service.

If the “standard function” is selected on the service selection screen G20 of FIG. 8A, the controller 101 reads from the memory 102 data that is used to display a menu screen listing options, such as a copying operation, a scanning operation, and a facsimile operation, and then displays the screen on the UI unit 106. The user selects a desired operation on the displayed menu screen. The controller 101 performs the operation selected by the user (the copying function, the scanning function, or the facsimile function) in accordance with the information output from the UI unit 106.

If the “scanning” operation is selected on the menu screen, the controller 101 displays a configuration screen for the functions related to the image reading (such as monochrome or color reading). The user sets a variety of configurations using the UI unit 106. The controller 101 modifies a configuration value for each function in accordance with the information output from the UI unit 106. If the configuration is not modified, the user selects a “start” button to instruct the scanning operation to be performed. When the “start” button is selected, the controller 101 performs an image processing operation in operation contents following the modified configuration value. If the configuration value is not modified, the controller 101 performs the image processing operation in accordance with a default configuration value. For example, if the configuration value as to whether to read an image in color or monochrome is “color”, the controller 101 instructs the image reading unit 104 to read an image in color. For example, if the configuration values of the “background removal function” and the “distortion correction” are both “on”, the controller 101 instructs the image reading unit 104 to perform the background removal operation and the correction operation.

In this example, the image processing apparatus 100 has a function of detecting the size of a medium placed on the platen glass, and is configured in advance so as to detect the size of the medium when an image reading instruction is provided. In the image reading, the image reading unit 104 detects the size of the medium placed on the platen glass, and reads the image in the detected size. The user places the medium on the platen glass with the edge of the medium aligned with a predetermined location (for example, at the top left corner) of the platen glass of the image reading unit 104. The image processing apparatus 100 may fail to detect the size if the medium, different from a predetermined standard size, such as a book or an envelope, is a reading target, or if the medium is not placed in a correct position. If the image processing apparatus 100 fails to detect the size of the medium, the controller 101 displays on the display of the UI unit 106 an indication that the size detection has failed while displaying a screen on the display prompting the user to specify the size.

The screen G21 of FIG. 8B is an example of a screen displayed on the UI unit 106 if the size detection has failed. As illustrated in FIG. 8B, the controller 101 displays a message reading “Size detection of original document has failed. Select reading size.” together with a menu for size selection on the UI unit 106. If the user specifies a size using the UI unit 106 with the screen G21 displayed, the controller 101 instructs the image reading unit 104 to read the image in the specified size. If the service of the “standard function” is selected, the controller 101 performs the image processing operation in the process contents in accordance with the configuration value of each function related to the image reading.

If the “book management” is selected on the service selection screen G20 of FIG. 8A, the controller 101 transmits an HTTP request to the URL associated with the soft button. In this example, the URL is the URL of the server apparatus 200. Upon receiving the HTTP request, the controller 210 in the server apparatus 200 accepts the selection of the service. The controller 210 reads from the memory 220 operation screen data responsive to the HTTP request, and then transmits the operation screen data to the image processing apparatus 100. The controller 101 in the image processing apparatus 100 displays the operation screen on the UI unit 106 in response to the received operation screen data.

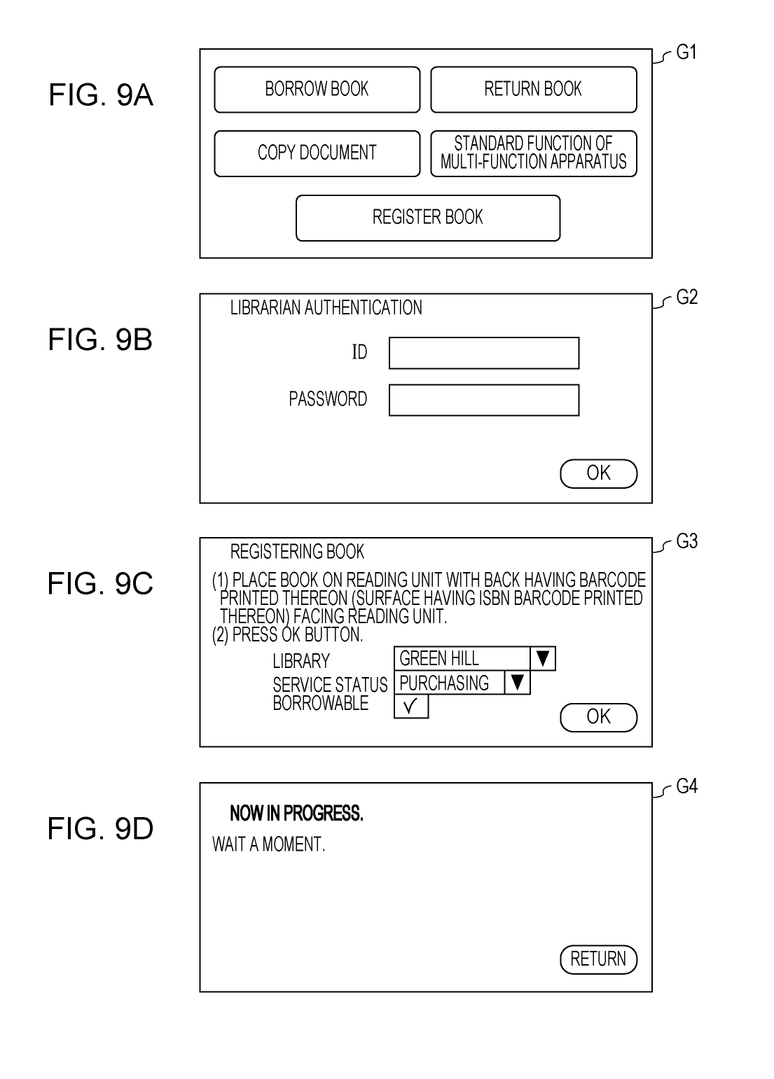

FIG. 9A through FIG. 9D illustrate examples of screens displayed on the UI unit 106 of the image processing apparatus 100. The user selects a desired operation in an operation selection screen G1 of FIG. 9A. FIG. 9A illustrates soft buttons “borrow book”, “return book”, “copy document”, and “register book”. Among these soft buttons, the soft buttons “borrow book”, “return book”, and “register book” are associated with respective URLs. When the user selects one of the soft buttons “borrow book”, “return book”, and “register book”, the controller 101 in the image processing apparatus 100 transmits an HTTP request to the URL associated with the selected operation. On the other hand, if the soft button “copy document” is selected, the controller 101 in the image processing apparatus 100 reads from the memory 102 screen data to be copied, and displays a screen responsive to the data on the UI unit 106. All the operations do not necessarily have to be provided to all users. More specifically, some of the operations may be provided to all the users, and the remaining operations may be provided to specific users. In such a case, a user is authenticated prior to displaying the operation selection screen G1, and the controller 101 displays the operation selection screen G1 that lists the operations available to the authenticated user. Alternatively, the controller 101 displays the operation selection screen G1 that lists the operations available to all the users, authenticates a user and then displays an operation available to the authenticated user. The display screen itself may be changed depending on whether the user is a standard user or a specific user. For example, the operation “register book” may be provided to a librarian only. The controller 101 may display the operation selection screen G1 not including the operation “register book” to standard users. After a librarian has been successfully authenticated with his or her ID and password input on a log-in screen G2 for librarian, the controller 101 reads from the memory 102 data to display a librarian-specific operation selection screen, and displays on the UI unit 106 a screen including the soft button of “register book”.

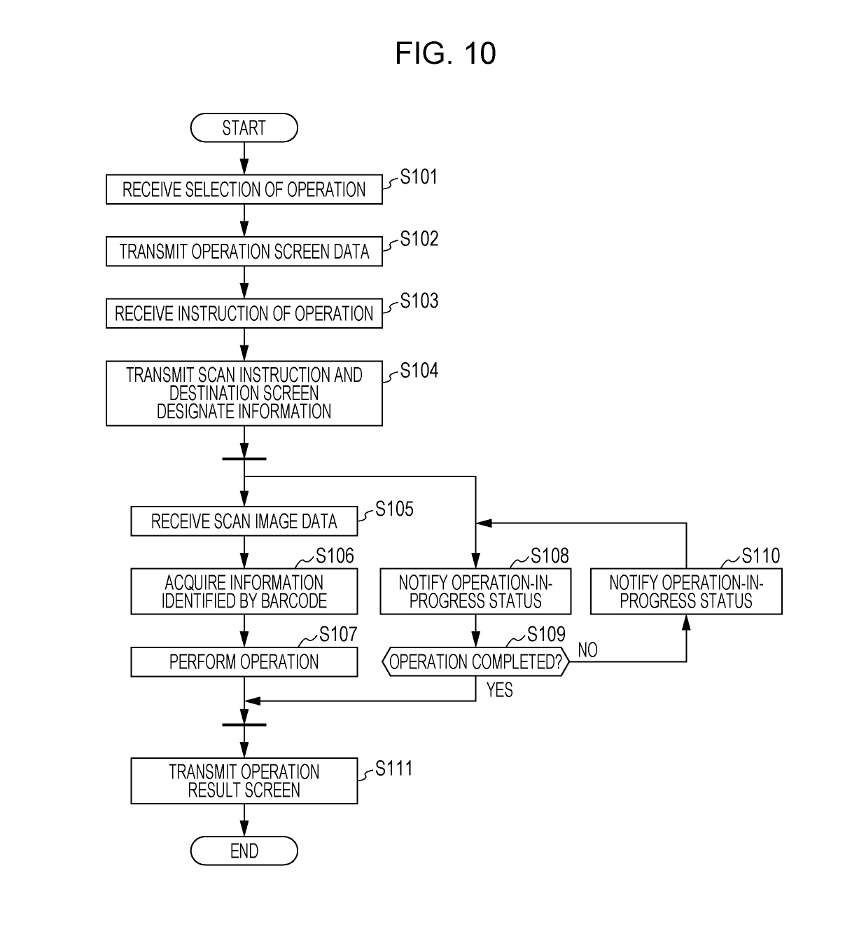

FIG. 10 is a flowchart illustrating a standard operation of the server apparatus in the book management service. In the operation example described below here, the user selects one of the soft buttons “borrow book”, “return book”, and “register book” on the image processing apparatus 100. The controller 101 in the image processing apparatus 100 transmits an HTTP request to the URL associated with the selected operation. In this example, these operations are performed by the server apparatus 200, and the URL is that of the server apparatus 200. Upon receiving the HTTP request, the controller 210 in the server apparatus 200 accepts the selection of the operation (step S101). The controller 210 reads from the memory 220 the operation screen data responsive to the HTTP request, and transmits the operation screen data to the image processing apparatus 100 (step S102).

The controller 101 in the image processing apparatus 100 displays the operation screen responsive to the operation screen data on the UI unit 106. For example, if a library registers a newly obtained book, a registration screen G3 (FIG. 9C) is displayed on the UI unit 106.

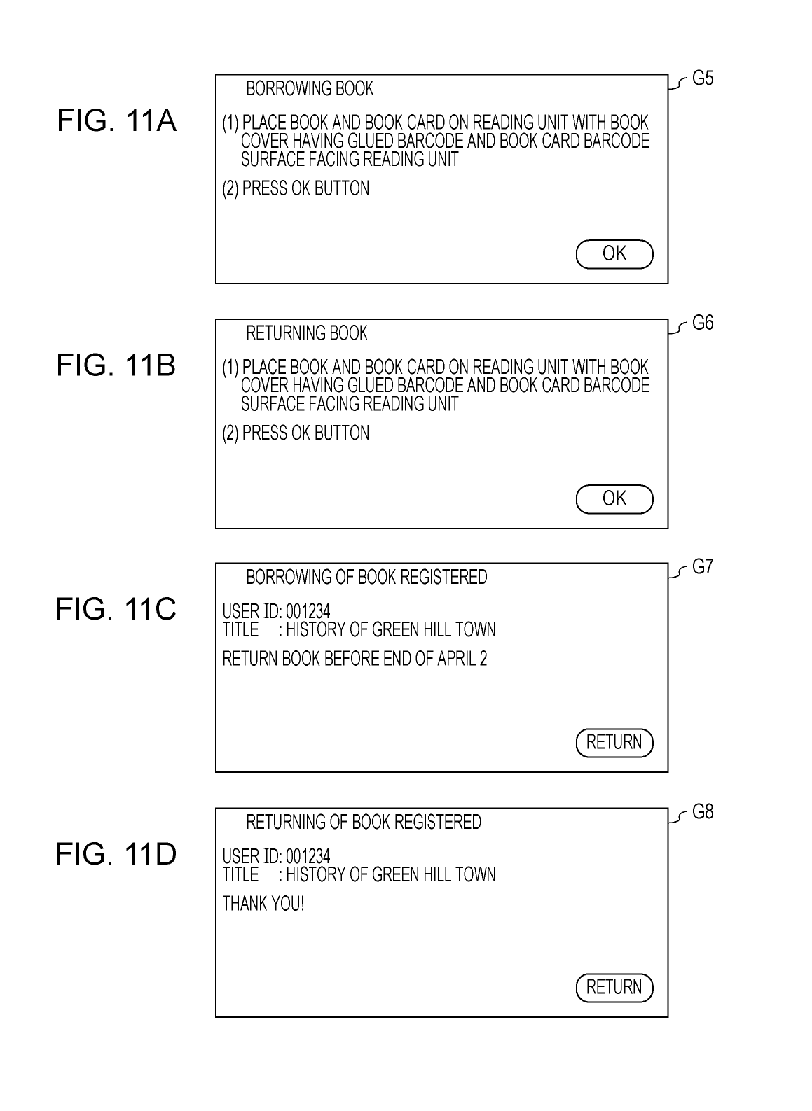

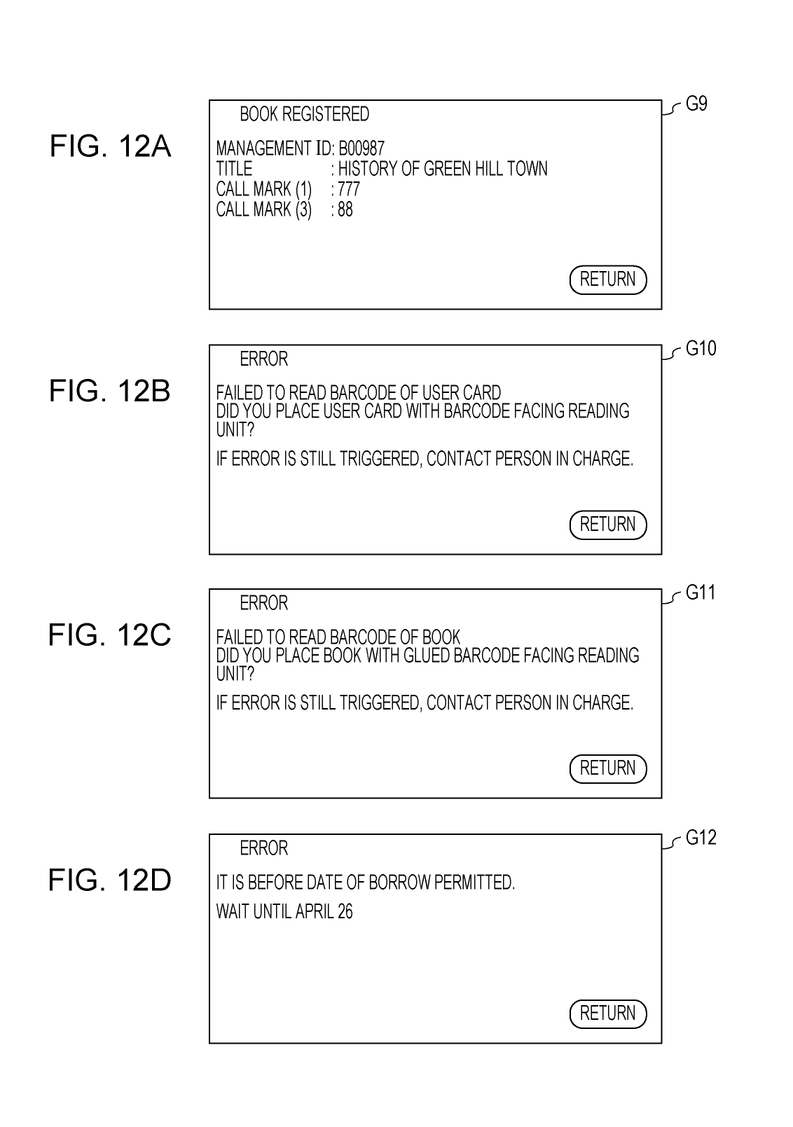

FIG. 11A through FIG. 11D and FIG. 12A through FIG. 12D illustrate examples of screens displayed on the UI unit 106 in the image processing apparatus 100. When the library lends a book (a user borrows the book), a lending operation screen G5 (FIG. 11A) is displayed on the UI unit 106. When the user returns a book, a return operation screen G6 (FIG. 11B) is displayed on the UI unit 106.

To register a book, the user places the book on the image processing apparatus 100 with a back cover 2 having the ISBN barcode 21 printed thereon facing the image reading unit 104, inputs related information in an entry field in the registration screen G3, and selects a soft button labeled “OK” (hereinafter referred to as an OK button). In this way, the identifier of the OK button, the value information thereof, and the information input in the entry field are thus transmitted to the URL associated with FORM tags of hypertext markup language (HTML) on the registration screen.

To borrow or return a book, the user places the book and the user card 4 on the image processing apparatus 100 with the cover 1 of the book having the management barcode 11 glued on and the user ID barcode of the user card 4 facing on the image reading unit 104. The user then selects the OK button on the lending operation screen G5 or the return operation screen G6. The image reading unit 104 then reads multiple codes from the book on the platen glass by a single scan. In this case, the user may place multiple books on the platen glass to read the codes thereof by a single scan, or may place the user card together with the multiple books on the platen glass to read the code from the user card. The identifier of the OK button and the value information thereof are transmitted to the URL associated with the HTML FORM tag on these screens.

A configuration button for the user to configure each of the variety of functions related to the image reading may be displayed on the registration screen G3, the lending operation screen G5, or the return operation screen G6. If the user modifies the variety of configurations by selecting the configuration button, information indicating the contents of modification is transmitted together with the identifier of the OK button and the value information thereof. The controller 101 may be configured such that the controller 101 does not receive, from the user, modification instruction for the configuration value of monochrome reading/color reading, the configuration value of the background removal function, or the configuration value of the distortion correction. More specifically, the controller 101 may be configured so as not to receive an instruction from the user if the instruction is for a predetermined configuration related to the image reading. For example, if the user attempts to set the configuration value of the correction function to “off” using the UI unit 106 before selecting the OK button, the controller 101 may display a message reading “This configuration is unmodifiable” on the UI unit 106 while not performing the modification actually.

The controller 210 in the server apparatus 200 accepts an instruction of an operation by receiving information transmitted from the image processing apparatus 100 (step S103). Note that a hard button disposed on the image processing apparatus 100 may receive an instruction identical to the instruction of the soft button. The hard button on the image processing apparatus 100 may be substituted for the function of the soft button with no soft button displayed on the UI unit 106.

The controller 210 in the server apparatus 200 transmits a scan instruction and destination screen designate information to the image processing apparatus 100 (step S104). The scan instruction includes parameters for scanning, such as a resolution of scanning (such as 300 dpi (dot/inch)), monochrome/color, and image format (such as TIFF format), and a URL indicating the transmission destination of the scan image data. The destination screen designate information is path information, such as URL, indicating a storage destination of screen data.

The controller 210 in the server apparatus 200 includes, in the scan instruction, a parameter indicating the image reading that is performed in a predetermined size (such as the overall size of the platen glass, a sheet A3 size, or the like) without performing a detection operation of the size of a medium as a reading target, a parameter indicating the image reading that is performed in monochrome (black and white), a parameter indicating an instruction to perform the background removal operation, and a parameter indicating an instruction to perform the distortion correction. More specifically, the controller 210 instructs the image processing apparatus 100 not to perform the size detection operation in the image reading operation while instructing the image processing apparatus 100 to perform the image reading in monochrome, the background removal operation, and the distortion correction operation.

The controller 101 in the image processing apparatus 100 generates scan image data by causing the image reading unit 104 to read an image in accordance with a parameter included in the received scan instruction. In this example, the controller 101 causes the image reading unit 104 to read an image in monochrome in a predetermined size in accordance with the parameter included in the received scan instruction, without detecting the size of the medium placed on the platen glass. The controller 101 also controls the image reading unit 104 to perform the background removal operation and the distortion correction operation. More specifically, the controller 101 controls the image reading unit 104 to perform a pre-scan to check the density of the background, and to read the image in accordance with the parameter responsive to the checked density. In the distortion correction, the controller 101 recognizes the outline edge of the book using a background sheet different in color from the cover color of the book, and performs the distortion correction operation in accordance with the recognition results. With the “book management” service selected, the controller 101 instructs the image reading unit 104 to read the image in monochrome even if the user does not instruct the configuration value to be modified. The controller 101 also controls the image reading unit 104 to perform the background removal operation and the distortion correction operation.

The controller 101 transmits the generated scan image data to the specified transmission destination. As appropriate, the controller 101 adds, to the scan image data, parameters during scanning, and meta information (the user information of an authenticated user, and the address of the image processing apparatus).

The controller 210 in the server apparatus 200 receives the scan image data transmitted from the image processing apparatus 100 (step S105). The controller 210 receives information identified by the barcode included in the scan image data (step S106). If multiple barcodes are included in the scan image data, the controller 210 acquires multiple pieces of information responsive to the multiple barcodes. The controller 210 determines whether an operation is executable using the acquired information. If the controller 210 determines that the operation is executable using the acquired information, the controller 210 performs the operation using the acquired information (step S107).

The controller 210 performs the registration operation, lending operation, return operation, or deletion operation of a book in step S107. More specifically, the controller 210 decodes one or more barcodes included in the scan image data, and acquires one or more pieces of information identified by the one or more barcodes. The controller 210 determines whether these pieces of information include a character string indicating a variety of information including ISBN, ISSN, user ID, or management number of a book or magazine. It is contemplated that each piece of information is determined according to each pre-fix. Each piece of information may also be determined according to the number of digits of the information or according to a check digit.

To register a book, the controller 210 identifies bibliographic information using the acquired pieces of information, extracts the management number to add a new record to the book DB 221, and thus registers information related to the book. To lend a book, the controller 210 updates the lending flag responsive to the management number registered in the book DB 221, the user ID, and the date of lending to the contents of lending, using the acquired user ID and management number. In response to returning the book, the lending flag responsive to the management number, the user ID, and the date of lending are updated to the contents of returning in a manner similar to the book lending. To delete a book from the database, the controller 210 references the management number acquired as a result of decoding the barcode. If the management number referenced indicates a book, the controller 210 deletes information responsive to the management number on the book DB 221. If the management number referenced indicates a magazine, the controller 210 deletes information responsive to the management number from the magazine DB 222.

Throughout steps S105 through S107, the controller 101 in the image processing apparatus 100 specifies the URL indicated by the destination screen designate information, and requests a status display screen from the server apparatus 200. If the operation in step S107 is not complete, the determination results in step S109 are non-affirmative, and the controller 210 in the server apparatus 200 transmits operation-in-progress-screen data (an operation-in-progress screen G4 of FIG. 9D) to the image processing apparatus 100 (steps S108 and S110). If the operation in step S107 is normally completed, the determination results in step S109 are affirmative, and the controller 210 transmits normally completed screen data (an operation result screen G7 or G8 of FIG. 11 or an operation result screen G9 of FIG. 12) to the image processing apparatus 100 (step S111). If the operation in step S107 is completed in error, the controller 210 transmits an error screen (an operation result screen G10, G11, or G12 of FIG. 12) to the image processing apparatus 100 (step S111).

In the standard scanning function, the size of an original document is to be recognized. When the scanned data is stored, the user may view the stored data later. If the data is stored in a size the user does not desire, it takes time to re-scan or edit the data. If the user knows the size of the data and performs the image processing operation in accordance with the size information, there is a possibility that a cleaner image is obtained with a shorter period of process time. This is because correct knowledge of the size in the image reading is useful to the user. For this reason, the user places the original document on the platen glass of the image reading unit 104 with the edge of the document engaged with a predetermined location of the platen glass (such as at the top left corner of the platen glass). If the original document is not correctly placed, the size of the original document may not be correctly recognized. Even if the edge of the original document is aligned with the predetermined location of the platen glass, the size of the original document, if in a non-standard size, may not be correctly recognized. The books handled in the book management service are various in size. If the size of a book is not recognized in the book management service, the user is to specify the size using the UI unit 106, and the operation for this may be complex.

In contrast, if the book management service is selected in the exemplary embodiment, the scan size is configured as a predetermined size (for example, the overall size of the platen glass) without performing the size detection operation.

Once the cover of a book is read in color, color shifting may be erroneously recognized as a barcode.

The cover of a book is typically covered with a texture, and the recognition of a barcode may be difficult. When a book is placed on the platen glass, a distortion may occur in the image reading depending on the manner in which the book is placed. In such a case, the barcode may be difficult to recognize. In practice, the distortion correction function is typically configured to be performed only if the user specifies the function because it takes a long process time and reading an original document that suffers from too much distortion does not occur so often. Also, configuring the distortion function to a detailed level may be complex. In the book management, however, the distortion correction, if performed, occasionally leads to a higher reliability in subsequent operations.

In the above example, the operation to manage books has been described as the book management service. The exemplary embodiment is not limited to managing books. The exemplary embodiment finds applications in managing an object tagged with identification information, such as a barcode. If the image reading unit 104 of the image processing apparatus 100 is a fixed type, any product, such as a compact disk or a digital video disk, which may be easily placed in a state that allows the identification information to be read by the fixed image reading unit, is appropriate.

The above example has been described in comparison with the “scan” as a standard function. Even when the “copy” is selected, the correct size recognition in the original document image reading is likely to match the size determination of the output sheet the user intends. The image processing apparatus 100 is thus designed to correctly detect the size of the medium as a standard function. A user or a service engineer, who has sufficient knowledge about appropriateness of the functions of the thus designed image processing apparatus 100, may re-configure the image processing apparatus 100 in terms of the default functions to his or her preference. In such a case, however, time and particular knowledge are needed.

When the user selects a soft button “in-house mail delivery” on the service selection screen G20 of FIG. 8A, the controller 101 transmits an HTTP request to the URL associated with this soft button. In this case, the URL is that of the server apparatus 200. By receiving the HTTP request, the controller 210 in the server apparatus 200 accepts the selection of the service. The controller 210 reads operation screen data responsive to the HTTP request from the memory 220, and then transmits the operation screen data to the image processing apparatus 100. The controller 101 in the image processing apparatus 100 displays the operation screen responsive to the received operation screen data on the UI unit 106.

The operation screen may display configuration buttons for the user to configure a variety of functions in the image reading (such as the distortion correction, the background removal, and the like). The controller 101 may not necessarily have to receive from the user a modification instruction related to the configuration value of monochrome reading/color reading. For example, if the user attempts to change the configuration value of the image reading to “color” using the UI unit 106, the controller 101 may display a message reading “This configuration is unmodifiable” while not performing the modification in practice.

The user places on the image reading unit 104 an original document (medium) to be transmitted as a mail, inputs information (such as transmission destination of the mail) in an entry field arranged on the screen displayed on the UI unit 106, and then selects the OK button. When the OK button is selected, the controller 101 in the image processing apparatus 100 transmits to the server apparatus 200 the identifier of the OK button, the value information thereof, and the information input in the entry field. If the configuration contents of a function related to the image reading are modified by the user, the controller 101 also transmits the information indicating the modification together with the identifier of the OK button and the value information thereof.

The controller 210 in the server apparatus 200 transmits a scan instruction and destination screen designate information to the image processing apparatus 100. The scan instruction includes parameters for scanning, such as a resolution of scanning, monochrome/color, and image format (such as TIFF format), and a URL indicating the transmission destination of the scan image data. The controller 210 includes, in the scan instruction, a parameter indicating that the image reading is to be performed in a predetermined size without performing the size detection operation of the medium serving as a reading target, and a parameter indicating that the image reading is to be performed in monochrome (black and white). The size of the image reading may be configured in accordance with a predetermined in-house format. In such a case, the controller 101 may configure a region slightly larger than the size of that format to be a target region. The controller 101 may configure the entire surface of the platen glass to be a target region. The controller 210 indicates to the image processing apparatus 100 that the size detection operation is not performed in the image reading operation while also indicating to the image processing apparatus 100 that the image reading is performed in monochrome.

The controller 101 in the image processing apparatus 100 generates the scan image data by causing the image reading unit 104 to read the image in accordance with the parameter included in the received scan instruction. In this example, the controller 101 causes the image reading unit 104 to read the image in monochrome in the predetermined size in accordance with the parameter included in the received scan instruction without performing the size detection operation of the medium placed on the platen glass. If the “in-house mail delivery” service is selected in this way, the controller 101 causes the image reading unit 104 to read the image in monochrome even if an instruction to modify the configuration value of monochrome/color has not been provided by the user.

The controller 101 transmits the generated scan image data to the specified transmission destination. As appropriate, the controller 101 adds, to the scan image data, parameters during scanning, and meta information (the user information of an authenticated user, the address of the image processing apparatus, or the like). The controller 210 in the server apparatus 200 receives the scan image data transmitted from the image processing apparatus 100, performs an operation on the received scan image data (such as a file format conversion operation), and transmitted as a mail the resulting data to the specified destination.

The medium read during the in-house mail delivery service may have a size (such as an envelope) different from the predetermined standard size. In such a case, an apparatus in the related art may fail to detect the size of the medium, and the user may configure the image processing apparatus 100 for a reading size using the UI unit 106.

If the user selects the soft button “marker masking” in the service selection screen G20 of FIG. 8A, the controller 101 transmits an HTTP request to the URL associated with this soft button. This URL is that of the server apparatus 200. By receiving the HTTP request, the controller 210 in the server apparatus 200 accepts the selection of the service. The controller 210 reads the operation screen data responsive to the HTTP request from the memory 220 and transmits the operation screen data to the image processing apparatus 100. The controller 101 in the image processing apparatus 100 displays the operation screen responsive to the operation screen data on the UI unit 106.

The operation screen may display configuration buttons for the user for a variety of functions in the image reading (such as the distortion correction, the background removal, and the like). The controller 101 may not necessarily have to receive from the user a modification instruction related to the configuration value of monochrome reading/color reading, or the configuration value of the monochrome outputting (or monochrome and red outputting)/color outputting. For example, if the user attempts to change the configuration value of the image reading to “monochrome outputting (or monochrome and red outputting)” using the UI unit 106, the controller 101 may display a message reading “This configuration is unmodifiable” while not performing the modification in practice.

The user places an original document (medium) to be marker-masked onto the image reading unit 104, and selects the OK button on the screen displayed on the UI unit 106. A desired area of the original document is colored by a marker pen predetermined by the user.

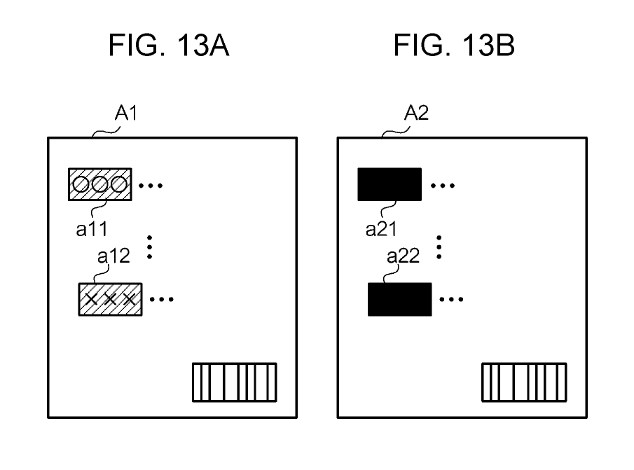

FIG. 13A and FIG. 13B illustrate examples of original documents. An original document A1 includes partial regions a11, a12, . . . colored by a marker pen. With the original document A1 placed on the image reading unit 104, the user may select the OK button on the screen displayed on the UI unit 106. If the OK button is selected, the controller 101 in the image processing apparatus 100 transmits the identifier of the OK button, the value information thereof, and the information input to the entry field to the server apparatus 200. If the configuration contents of functions related to the image reading are modified by the user, information indicating the modification is also transmitted together with the identifier of the OK button and the value information thereof.

The controller 210 in the server apparatus 200 transmits a scan instruction and destination screen designate information to the image processing apparatus 100. The scan instruction includes parameters for scanning, such as a resolution of scanning, monochrome/color, and image format (such as TIFF format), and a URL indicating the transmission destination of the scan image data. The controller 210 includes, in the scan instruction, a parameter indicating that the image reading is to be performed in color, and a parameter indicating that image outputting is to be performed in monochrome (or monochrome and red).

The controller 101 in the image processing apparatus 100 generates the scan image data by causing the image reading unit 104 to read the image in accordance with the parameter included in the received scan instruction. In this example, the controller 101 causes the image reading unit 104 to read the image in color in accordance with the parameter included in the received scan instruction, and transmits the generated scan image data to the specified destination. As appropriate, the controller 101 adds, to the scan image data, parameters during scanning, and meta information (the user information of an authenticated user, or the address of the image processing apparatus).

The controller 210 in the server apparatus 200 receives the scan image data transmitted from the image processing apparatus 100, and analyzes the received scan image data. The controller 210 masks a region of a predetermined color in response to the analysis results, and transmits image data representing the analysis results to the image processing apparatus 100. Upon receiving the image data from the server apparatus 200, the image processing apparatus 100 causes the received image data to be output in monochrome (or monochrome and red) to the image forming unit 103. When the “marker masking” service is selected in this way, the controller 101 causes the image reading unit 104 to read an image in color and the image forming unit 103 to form an image in monochrome (or monochrome and red) regardless of whether the user has instructed the configuration values of the image reading and image outputting to be modified.

FIG. 13B illustrates an original document A2 which is an example of results of a marker masking operation performed by the image processing apparatus 100. Referring to FIG. 13B, regions a21, a22, . . . are masked and then output.

If the image reading is performed in monochrome in an operation to detect a region that is colored with a predetermined color, there is a possibility that the colored region escapes detection. For this reason, the image reading is performed in color in the marker masking operation. Since the operation results of the marker masking are output in monochrome (or monochrome and red), the user may erroneously configure an apparatus of the related art for monochrome reading. In accordance with the exemplary embodiment, the color image reading is performed if the marker masking service is selected.

The exemplary embodiment described above is one exemplary embodiment of the present invention, and may be modified as described below. The exemplary embodiment and modification described below may be combined.

The entities that perform the operations in the flowchart of FIG. 10 is not limited to those described above. For example, the operations in step S103 and S104 may be performed by the image processing apparatus 100 rather than the server apparatus 200.

In the book management service, the entire platen glass is the target of image reading, but the manner of the image processing apparatus 100 to read the medium is not limited to this method. For example, the image processing apparatus 100 may read a barcode portion glued on the medium instead of reading the entire medium. In such a case, the image reading unit 104 in the image processing apparatus 100 may identify a barcode region through scanning, and may generate the image of the identified region as the scan image data.

In the exemplary embodiment, information identifying the position and direction of the barcode may be attached to the platen glass or book. For example, the image of a rectangular outline enclosing the barcode may be used as the information identifying the position and direction of the barcode. In such a case, the controller 210 in the server apparatus 200 analyzes the scan image data transmitted from the image processing apparatus 100, and identifies a region of a rectangular outline of a predetermined size as a barcode region. The controller 210 acquires, from the identified region, information identified by the barcode. This arrangement makes the position and direction of the barcode to be more easily identified than another arrangement without using the rectangular outline.

Another example of the information identifying the position and direction of the barcode is information indicating the position and/or direction of the barcode (such as QR code (registered trademark)) attached at a predetermined location of a book or platen glass (such as the top left corner of the platen glass). In such a case, the controller 210 in the server apparatus 200 analyzes the scan image data transmitted from the image processing apparatus 100, identifies the location of the barcode in the image in accordance with the information indicating the position and/or direction included in the scan image data, and then acquires the information identified by the barcode at the identified location. This arrangement facilitates identifying the position and direction of the barcode. Since the position of the barcode within books is largely fixed, the controller 210 may search the corresponding region for the barcode with a higher priority. The controller 210 may recognize the outline form of a book through pre-scanning, determine the location candidate of the barcode within the possible region derived from the recognized outline form, and then search the location candidate for the barcode with a higher priority. For example, if the outline is a rectangular shape, the location candidate may include two locations along the diagonal lines. The user may be prompted to place a book such that the barcode is closer to a location serving as a reference point where the original document is placed, for example, at the left deepest point of the platen glass. In this case, a region on and surrounding the left deepest point of the platen glass is searched with a higher priority.

In the exemplary embodiment described above, the image reading is performed in the predetermined reading size in the book management service or the in-house mail delivery service without the image processing apparatus 100 performing the size detection of the medium. Alternatively, the image processing apparatus 100 may perform the size detection of the medium in the book management service or the in-house mail delivery service. In the case of a failure to detect the size of the medium, however, the controller 101 in the image processing apparatus 100 performs the image reading in the predetermined size without displaying the screen that prompts the user to specify the size.

In the exemplary embodiment described above, the service is performed over the network. The present invention is not limited to this method. The image processing apparatus 100 alone may provide the services. For example, the image processing apparatus 100 may manage the book lending and returning service alone using data stored on a memory therewithin without performing the book registering operation.

In the exemplary embodiment described above, the services available to the user includes “standard function”, “book management”, “in-house mail delivery”, and “marker masking”. The services available to the user are not limited to those services. For example, the system including the image processing apparatus 100 may provide another service, such as a storage service.

The present invention may be provided in the form of a program, or a recording medium having stored the program. The program related to the present invention may be downloaded to a computer via a network, such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an instruction unit that instructs an image reading unit to read an image in accordance with a predetermined configuration related to image reading if a predetermined service is selected from among a plurality of services; and
an execution unit that performs an operation responsive to the selected service using operation results of the image reading unit.

2. The information processing apparatus according to claim 1, wherein no instruction related to the predetermined configuration is received from a user.

3. The information processing apparatus according to claim 1, wherein the predetermined service comprises a book management service to manage a product using the read image or a delivery monitoring service to monitor a delivery status of the read image that is being delivered, and
wherein the instruction unit instructs the image reading unit to read the image in accordance with a predetermined size without detecting a size of a medium serving as a target of image reading if the predetermined service is selected.

4. The information processing apparatus according to claim 2, wherein the predetermined service comprises a book management service to manage a product using the read image or a delivery monitoring service to monitor a delivery status of the read image that is being delivered, and
wherein the instruction unit instructs the image reading unit to read the image in accordance with a predetermined size without detecting a size of a medium serving as a target of image reading if the predetermined service is selected.

5. The information processing apparatus according to claim 1, wherein the predetermined service comprises a book management service to manage a product using the read image or a delivery monitoring service to monitor a delivery status of the read image that is being delivered, and
wherein the instruction unit instructs the image reading unit to perform a monochrome image reading operation from among color image reading and monochrome image reading operations if the predetermined service is selected.

6. The information processing apparatus according to claim 2, wherein the predetermined service comprises a book management service to manage a product using the read image or a delivery monitoring service to monitor a delivery status of the read image that is being delivered, and
wherein the instruction unit instructs the image reading unit to perform a monochrome image reading operation from among color image reading and monochrome image reading operations if the predetermined service is selected.

7. The information processing apparatus according to claim 1, wherein the predetermined service comprises a marker masking service to mask a predetermined color area, and
wherein the instruction unit instructs the image reading unit to perform a color image reading operation from among color image reading and monochrome image reading operations if the marker masking service is selected.

8. The information processing apparatus according to claim 2, wherein the predetermined service comprises a marker masking service to mask a predetermined color area, and
wherein the instruction unit instructs the image reading unit to perform a color image reading operation from among color image reading and monochrome image reading operations if the marker masking service is selected.

9. The information processing apparatus according to claim 1, wherein the predetermined service comprises a book management service to manage a product using the read image, and
wherein the instruction unit instructs the image reading unit to remove a background from a medium as an image reading target if the book management service is selected.

10. The information processing apparatus according to claim 2, wherein the predetermined service comprises a book management service to manage a product using the read image, and
wherein the instruction unit instructs the image reading unit to remove a background from a medium as an image reading target if the book management service is selected.

11. The information processing apparatus according to claim 1, wherein the predetermined service comprises a book management service to manage a product using the read image, and
wherein the instruction unit instructs the image reading unit to perform a correction operation to correct a distortion in the read image if the book management service is selected.

12. The information processing apparatus according to claim 2, wherein the predetermined service comprises a book management service to manage a product using the read image, and
wherein the instruction unit instructs the image reading unit to perform a correction operation to correct a distortion in the read image if the book management service is selected.

13. The information processing apparatus according to claim 1, wherein the predetermined service comprises a marker masking service to mask a predetermined color area, and
wherein the instruction unit instructs the image reading unit to output a monochrome image output from among monochrome image and color image outputs if the marker masking service is selected.

14. The information processing apparatus according to claim 2, wherein the predetermined service comprises a marker masking service to mask a predetermined color area, and
wherein the instruction unit instructs the image reading unit to output a monochrome image output from among monochrome image and color image outputs if the marker masking service is selected.

15. The information processing apparatus according to claim 1, wherein the predetermined service comprises a book management service to manage a product using the read image or a delivery monitoring service that monitors a delivery status of the read image that is delivered, and
wherein if the predetermined service is selected and size detection of a medium as an image reading target fails, the instruction unit instructs the image reading unit to read the image in accordance with a predetermined size without displaying an image that is provided to cause a user to specify the size of the medium as the image reading target.

16. The information processing apparatus according to claim 2, wherein the predetermined service comprises a book management service to manage a product using the read image or a delivery monitoring service that monitors a delivery status of the read image that is delivered, and
wherein if the predetermined service is selected and size detection of a medium as an image reading target fails, the instruction unit instructs the image reading unit to read the image in accordance with a predetermined size without displaying an image that is provided to cause a user to specify the size of the medium as the image reading target.

17. An information processing method comprising:
instructing an image reading unit to read an image in accordance with a predetermined configuration related to image reading if a predetermined service is selected from among a plurality of services; and
performing an operation responsive to the selected service using operations results of the image reading unit.

18. A non-transitory computer readable medium storing a program causing a computer to execute a process for processing information, the process comprising:
instructing an image reading unit to read an image in accordance with a predetermined configuration related to image reading if a predetermined service is selected from among a plurality of services; and
performing an operation responsive to the selected service using operation results of the image reading unit.
